(19) United States
(12) Patent Application Publication
(10) Pub. No.: US 2014/0143491 A1
(43) Pub. Date: May 22, 2014

(54) SEMICONDUCTOR APPARATUS AND OPERATING METHOD THEREOF

(71) Applicant: SK HYNIX INC., Icheon-si (KR)

(72) Inventor: Hong Sik KIM, Icheon-si (KR)

(73) Assignee: SK HYNIX INC., Icheon-si (KR)

(21) Appl. No.: 13/846,066

(22) Filed: Mar. 18, 2013

(30) Foreign Application Priority Data
Nov. 20, 2012 (KR) 10-2012-0131430

(51) Int. Cl. G06F 12/08

(52) U.S. Cl. CPC G06F 12/0802
USPC 711/118

(57) ABSTRACT

A semiconductor apparatus includes stacked memory dies; a controller configured to control the memory dies; and a base die configured to electrically connect the memory dies and the controller. The base die includes a control unit configured to receive an external address, a request and external data from the controller; a memory input interface configured to receive a memory control signal for controlling the memory dies, from the control unit, and first cache data, and output an internal address, an internal command and internal data to the memory dies; a write cache memory configured to receive a cache control signal and transfer data from the control unit, output the first cache data to the memory input interface, and output second cache data to a memory output interface; and the memory output interface configured to output the second cache data and stored data inputted from the memory dies, to the controller.

### CROSS-REFERENCES TO RELATED APPLICATION

The present application claims priority under 35 U.S.C. §119(a) to Korean application number 10-2012-0131430, filed on Nov. 20, 2012, in the Korean Intellectual Property Office, which is incorporated herein by reference in its entirety.

### BACKGROUND

1. Technical Field

Various embodiments relate to a semiconductor integrated circuit, and more particularly, to a semiconductor apparatus with a controller and an operating method thereof.

2. Related Art

A semiconductor apparatus, especially, a semiconductor memory apparatus is configured to store data and output stored data. In order to increase the data storage capacity of the semiconductor memory apparatus, research for high integration of the semiconductor memory apparatus has been conducted. Currently, in order to increase the data storage capacity of the semiconductor memory apparatus, a stacked semiconductor apparatus is used.

Referring to FIG. 1, a stacked semiconductor apparatus 1 may include a base die 10, a plurality of memory dies 20, 30 and 40 including data storage regions and a controller 50.

The base die 10, the memory dies 20, 30 and 40, and the controller 50 are electrically connected with one another.

The base die 10 may include control circuits for controlling the memory dies 20, 30 and 40 according to a command from the controller 50.

In order to increase the operation speed of such a stacked semiconductor apparatus, research has been continuously conducted to include circuits for controlling the memory dies 20, 30 and 40, in the base die 10.

### SUMMARY

In an embodiment of the present invention, a semiconductor apparatus includes: memory dies stacked upon one another; a controller configured to control the memory dies; and a base die configured to electrically connect the memory dies and the controller, the base die including: a control unit configured to receive an external address, a request and external data from the controller; a memory input interface configured to receive a memory control signal for controlling the memory dies, from the control unit, and first cache data, and output an internal address, an internal command and internal data to the memory dies; a write cache memory configured to receive a cache control signal and transfer data from the control unit, output the first cache data to the memory input interface, and output second cache data to a memory output interface; and the memory output interface configured to output the second cache data and stored data inputted from the memory dies, to the controller.

In an embodiment of the present invention, a method for operating a semiconductor apparatus includes: comparing an external address and an address of a write cache memory; outputting data stored in the write cache memory when a request is read and the external address and the address of the write cache memory correspond to each other; outputting data stored in memory dies when the request is read and the external address and the address of the write cache memory do not correspond to each other; storing external data in the write cache memory when the request is write and the external address and the address of the write cache memory correspond to each other; storing data stored in the write cache memory, in the memory dies, and storing the external data in the write cache memory, when the request is write and the external address and the address of the write cache memory do not correspond to each other; and storing data stored in the write cache memory, in the memory dies when the memory dies do not perform read and write operations.

### BRIEF DESCRIPTION OF THE DRAWINGS

Features, aspects, and embodiments are described in conjunction with the attached drawings, in which:

FIG. 1 is a perspective view of a conventional semiconductor apparatus;

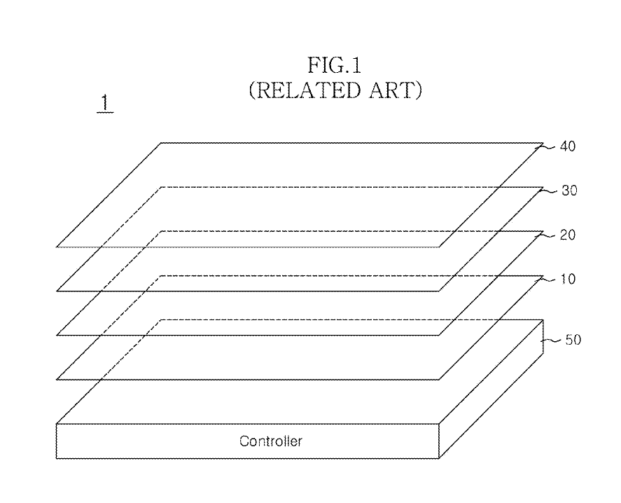

FIG. 2 is a block diagram of a base die constituting a semiconductor apparatus in accordance with an embodiment of the present invention; and

FIG. 3 is a flow chart explaining a write cache memory.

### DETAILED DESCRIPTION

Hereinafter, a semiconductor apparatus and an operating method thereof according to the present invention will be described below with reference to the accompanying drawings through exemplary embodiments.

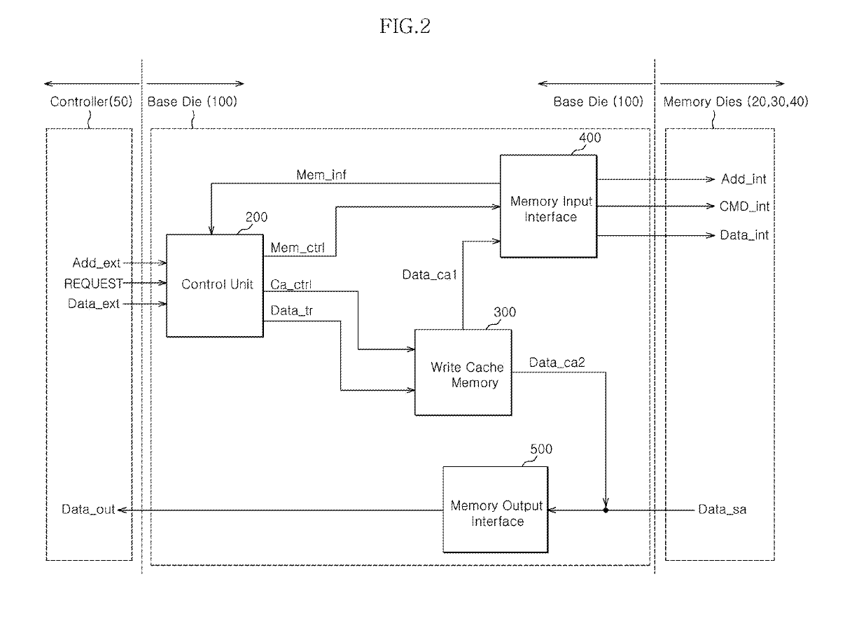

Referring to FIG. 2, a semiconductor apparatus 1000 may include a base die 100 which electrically connects a controller 50 and memory dies 20, 30 and 40.

The base die 100 may include a control unit 200, a write cache memory 300, a memory input interface 400, and a memory output interface 500.

The control unit 200 may be configured to generate a memory control signal Mem_ctrl, a cache control signal Ca_ctrl and transfer data Data_tr in response to an external address Add_ext, a request REQUEST and external data Data_ext which are received from the controller 50 and a state information signal Mem_inf which is received from the memory input interface 400. For example, the control unit 200 may buffer and decode the request REQUEST and generate the memory control signal Mem_ctrl. Further, the control unit 200 may buffer the external address Add_ext and output the memory control signal Mem_ctrl. Therefore, the memory control signal Mem_ctrl may include information of both the request REQUEST and the external address Add_ext. Also, the control unit 200 may output the external data Data_ext as the transfer data Data_tr to the write cache memory 300 in response to the request REQUEST. The control unit 200 may generate the cache control signal Ca_ctrl in response to the state information signal Mem_inf and the request REQUEST.

The write cache memory 300 may be configured to store the transfer data Data_tr and output the data stored therein as first cache data Data_ca1 or second cache data Data_ca2 in response to the cache control signal Ca_ctrl. Further, the write cache memory 300 may be configured to output the transfer data Data_tr as the second cache data Data_ca2 in response to the cache control signal Ca_ctrl.

The memory input interface 400 may be configured to generate an internal command CMD_int and an internal address Add_int for controlling the memory dies 20, 30 and 40, in response to the memory control signal Mem_ctrl. Also, the memory input interface 400 may be configured to output the first cache data Data_ca1 to the memory dies 20, 30 and 40 in response to the memory control signal Mem_ctrl.

The memory output interface 500 may be configured to output stored data Data_sa outputted from the memory dies 20, 30 and 40, to the controller 50, or output the second cache data Data_ca2 outputted from the write cache memory 300.

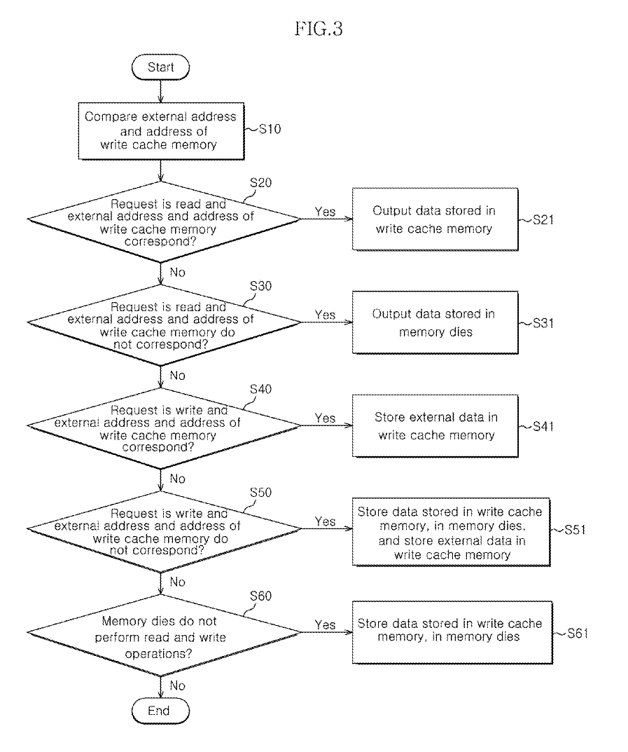

Operations of the semiconductor apparatus in accordance with the embodiment of the present invention, configured as mentioned above, will be described with reference to FIGS. 2 and 3.

The control unit 200 may receive the external address Add_ext, the external data Data_ext and the request REQUEST from the controller 50.

In step S10, the external address Add_ext and the address of the write cache memory 300 are compared in the control unit 200. For example, in the step S10, the control unit 200 compares the external address Add_ext inputted from the controller 50 and the address of the data stored in the write cache memory 300.

In step S20, it is determined whether the request REQUEST is a read command and the external address Add_ext corresponds to the address of the write cache memory 300, in the control unit 200. If the request REQUEST is the read command and the external address Add_ext corresponds to the address of the write cache memory 300, in step S21, the data stored in the write cache memory 300 may be outputted from the control unit 200. For example, in the step S21, the control unit 200 may output the cache control signal Ca_ctrl to the write cache memory 300, to output the data corresponding to the external address Add_ext. The write cache memory 300 which has received the cache control signal Ca_ctrl may output the data corresponding to the external address Add_ext, as the second cache data Data_ca2 to the memory output interface 500. The memory output interface 500 may output the second cache data Data_ca2 as output data Data_out to the controller 50.

In the step S20, if determination is made to No regarding whether the request REQUEST is the read command and the external address Add_ext does not corresponds to the address of the write cache memory 300, the procedure proceeds to step S30.

In the step S30, it is determined whether the request REQUEST is the read command and the external address Add_ext does not correspond to the address of the write cache memory 300.

If the request REQUEST is the read command and the external address Add_ext does not correspond to the address of the write cache memory 300 (when determination is made to Yes), in step S31, the data stored in the memory dies 20, 30 and 40 are outputted from the control unit 200. For example, in the step S31, the control unit 200 may output the memory control signal Mem_ctrl to the memory input interface 400 in order to the data corresponding to the external address Add_ext to the memory dies 20, 30 and 40. The memory input interface 400 which has received the memory control signal Mem_ctrl may output the internal command CMD_int and the internal address Add_int to the memory dies 20, 30 and 40 to output the data corresponding to the external address Add_ext. The memory dies 20, 30 and 40 which have received the internal command CMD_int and the internal address Add_int may output the stored data Data_sa stored therein to the memory output interface 500. The memory output interface 500 may output the stored data Data_sa inputted thereto, as the output data Data_out to the controller 50.

In the step S30, if determination is made to No regarding whether the request REQUEST is the read command and the external address Add_ext does not correspond to the address of the write cache memory 300, the procedure proceeds to step S40.

In the step S40, it is determined whether the request REQUEST is a write command and the external address Add_ext corresponds to and the address of the write cache memory 300. For example, in the step S40, the control unit 200 determines whether the request REQUEST provided from the controller 50 is the write command and the external address Add_ext corresponds to and the address of the data stored in the write cache memory 300.

If the request REQUEST is the write command and the external address Add_ext corresponds to the address of the data stored in the write cache memory 300 (when determination is made to Yes), in step S41, the external data Data_ext is stored in the write cache memory 300. For example, in the step S41, the control unit 200 may output the external data Data_ext as the transfer data Data_tr to the write cache memory 300. Further, the control unit 200 may output the cache control signal Ca_ctrl to the write cache memory 300 to store the transfer data Data_tr in a position corresponding to the external address Add_ext.

In the step S40, if determination is made to No regarding whether the request REQUEST is the write command and the external address Add_ext corresponds to the address of the data stored in the write cache memory 300, the procedure proceeds to step S50.

In the step S50, it is determined whether the request REQUEST is the write command and the external address Add_ext does not correspond to the address of the data stored in the write cache memory 300. For example, in the step S50, the control unit 200 determines whether the request REQUEST provided from the controller 50 is the write command and the external address Add_ext does not correspond to the address of the data stored in the write cache memory 300 do not correspond to each other.

If the request REQUEST is the write command and the external address Add_ext does not correspond to the address of the data stored in the write cache memory 300 (when determination is made to Yes), in step S51, the data stored in the write cache memory 300 is stored in the memory dies 20, 30 and 40, and the external data Data_ext is stored in the write cache memory 300. For example, in the step S51, the control unit 200 outputs the cache control signal Ca_ctrl to the write cache memory 300 to output the data stored therein. The write cache memory 300 which has received the cache control signal Ca_ctrl to output the data stored therein outputs the data stored therein, as the first cache data Data_ca1 to the memory input interface 400. Moreover, the control unit 200 may output the memory control signal Mem_ctrl to the memory input interface 400 to output the first cache data Data_ca1 to the memory dies 20, 30 and 40. The memory input interface 400 may output the internal address Add_int and the internal command CMD_int to the memory dies 20, 30 and 40 in response to the memory control signal Mem_ctrl. Also, the memory input interface 400 may output the first cache data Data_ca1 as internal data Data_int to the memory dies 20, 30 and 40. If the data stored in the write cache memory 300 is transferred to the memory dies 20, 30 and 40, the control unit 200 may output the external data Data_ext as the transfer data Data_tr to the write cache memory 300, and output the cache control signal Ca_ctrl to the write cache memory 300 to store the transfer data Data_tr. The write cache memory 300 may store the transfer data Data_tr in response to the cache control signal Ca_ctrl.

In the step S50, if determination is made to No regarding whether the request REQUEST is a write command and the external address Add_ext does not correspond to the address of the data stored in the write cache memory 300, the procedure proceeds to step S60.

In the step S60, it is determined whether the memory dies 20, 30 and 40 do not perform read and write operations. For example, the memory input interface 400 may output the internal command CMD_int to perform a read or write operation, to the memory dies 20, 30 and 40, and output the internal address Add_int to be used in the read or write operation, to the memory dies 20, 30 and 40. Thus, information related to operations of the memory dies 20, 30 and 40 is stored in the memory input interface 400. The memory input interface 400 may output the information, as the state information signal Mem_inf to the control unit 200. The control unit 200 may determine whether the memory dies 20, 30 and 40 do not perform read and write operations, in response to the state information signal Mem_inf.

If the memory dies 20, 30 and 40 do not perform read and write operations (when determination is made to Yes), in step S61, the data stored in the write cache memory 300 is stored in the memory dies 20, 30 and 40. For example, in the step S61, the control unit 200 outputs the cache control signal Ca_ctrl to the write cache memory 300 to output the data stored therein, as the first cache data Data_ca1 in response to the state information signal Mem_inf. The write cache memory 300 may output the data stored therein, as the first cache data Data_ca1 to the memory input interface 400. Furthermore, the control unit 200 may output the memory control signal Mem_ctrl to the memory input interface 400 to output the first cache data Data_ca1 to the memory dies 20, 30 and 40. The memory input interface 400 may output the first cache data Data_ca1 as the internal data Data_int to the memory dies 20, 30 and 40 in response to the memory control signal Mem_ctrl. Also, the memory input interface 400 may output the internal address Add_int and the internal command CMD_int to the memory dies 20, 30 and 40 in response to the memory control signal Mem_ctrl. In further detail, in the step S61, the control unit 200 receives addresses of word lines which are currently enabled in the memory dies 20, 30 and 40 after the read and write operations of the memory dies 20, 30 and 40 are performed, as the state information signal Mem_inf. The control unit 200 which has received the state information signal Mem_inf may control the write cache memory 300 to output the data of the write cache memory 300 which have addresses corresponding to the addresses of the enabled word lines, as the first cache data Data_ca1 to the memory input interface 400.

According to the semiconductor apparatus in accordance with the embodiment of the present invention, since a base die disposed between a controller and memory dies is configured to include a write cache memory, write data may be temporarily stored in the write cache memory. When the read operation, the external address provided with the read command (or read request) is compared with the address of the data stored in the write cache memory to output the data stored in the write cache memory. Thus, the operation speed may be improved. Also, when the read or write operation of the memory dies are not performed, the data stored in the write cache memory stores in the memory dies, whereby a write operation speed may be increased.

While certain embodiments have been described above, it will be understood to those skilled in the art that the embodiments described are by way of example only. Accordingly, the semiconductor apparatus and the operating method thereof described herein should not be limited based on the described embodiments. Rather, the semiconductor apparatus and the operating method thereof described herein should only be limited in light of the claims that follow when taken in conjunction with the above description and accompanying drawings.

What is claimed is:

1. A semiconductor apparatus comprising:
memory dies stacked upon one another;
a controller configured to control the memory dies; and
a base die configured to electrically connect the memory dies and the controller,
wherein the base die comprising:
a control unit configured to receive an external address, a request and external data from the controller;
a memory input interface configured to receive a memory control signal for controlling the memory dies, from the control unit, and first cache data, and output an internal address, an internal command and internal data to the memory dies;
a write cache memory configured to receive a cache control signal and transfer data from the control unit, output the first cache data to be provided to the memory input interface, and a second cache data; and
a memory output interface configured to output the second cache data provided from the write cache memory and stored data provided from the memory dies, to the controller.

2. The semiconductor apparatus according to claim 1, wherein the memory input interface is configured to output information on operations of the memory dies, as a state information signal to the control unit.

3. The semiconductor apparatus according to claim 2, wherein the control unit is configured to generate the memory control signal and the cache control signal in response to the request, the state information signal and the external address, and output the external data as the transfer data to the write cache memory.

4. The semiconductor apparatus according to claim 2, wherein the write cache memory is configured to store the transfer data in response to the cache control signal, and output data stored therein as the first cache data or the second cache data.

5. The semiconductor apparatus according to claim 2, wherein the memory input interface is configured to generate the internal address and the internal command in response to the memory control signal, and output the first cache data as the internal data in response to the memory control signal.

6. A method for operating a semiconductor apparatus, comprising:
comparing an external address and an address of a write cache memory;
outputting data stored in the write cache memory when a request is a read command and the external address corresponds to the address of the write cache memory;
outputting data stored in memory dies when the request is the read command and the external address does not correspond to the address of the write cache memory do not correspond to each other;
storing external data in the write cache memory when the request is a write command and the external address corresponds to the address of the write cache memory;
storing data stored in the write cache memory, in the memory dies, and storing the external data in the write cache memory, when the request is the write command and the external address does not correspond to the address of the write cache memory; and
storing data stored in the write cache memory, in the memory dies when read and write operations of the memory dies are not performed.

7. The method according to claim 6, wherein the comparing the external address and the address of the write cache memory is performed in a control unit.

8. The method according to claim 7, wherein the outputting of the data stored in the write cache memory when the request is the read command and the external address corresponds to and the address of the write cache memory correspond to each other, comprises:
determining whether the request is the read command and the external address corresponds to the address of the write cache memory in the control unit; and
outputting a cache control signal to cause the write cache memory to output the data stored therein, to the write cache memory.

9. The method according to claim 8, wherein the outputting of the data stored in the memory dies when the request is the read command and the external address does not correspond to the address of the write cache memory, comprises:
determining whether the request is the read command and the external address does not correspond to the address of the write cache memory in the control unit, and transferring a memory control signal for outputting the data stored in the memory dies to the memory input interface; and
outputting an internal address corresponding to the external address and an internal command in the memory input interface, to the memory dies by the memory control signal provided from the control unit.

10. The method according to claim 9, wherein the storing of the external data in the write cache memory when the request is the write command and the external address corresponds to the address of the write cache memory, comprises:
determining whether the request is the write mode and the external address corresponds to the address of the write cache memory in the control unit; and
outputting the cache control signal to the write cache memory to store the external data and the external data as transfer data.

11. The method according to claim 10, wherein the storing of the data stored in the write cache memory, in the memory dies, and storing the external data in the write cache memory, when the request is the write command and the external address does not correspond to the address of the write cache memory, comprises:
determining whether the request is the write command and the external address does not correspond to the address of the write cache memory;
generating the cache control signal to output the data stored therein as first cache data;
generating the memory control signal to the memory dies in the control unit;
outputting the data stored therein, as the first cache data to the memory input interface by inputting the cache control signal, and providing the first cache data to the memory dies.

12. The method according to claim 11, wherein the storing of the data stored in the write cache memory, in the memory dies when the read and write operations of the memory dies are not performed, comprises:
determining whether the read and write operations of the memory dies are not performed;
outputting the data stored in the write cache memory, as the first cache data to the memory input interface; and
outputting the memory control signal to output the first cache data to the memory dies, to the memory input interface.

13. The method according to claim 12, wherein the determining whether the read and write operations of the memory dies are not performed comprises outputting stored data of the write cache memory which correspond to addresses of enabled word lines in the memory dies, to the memory dies.

14. A semiconductor system multi-stacked dies and a controller for controlling the multi-stacked dies, comprising:
a base die configured to dispose between the multi-stacked dies and the controller, electrically connect between the multi-stacked dies and the controller and include a write cache memory configured to temporary store write data.
